(19) United States
(12) Patent Application Publication
(10) Pub. No.: US 2010/0028019 A1
(43) Pub. Date: Feb. 4, 2010

(54) DISPLAY SYSTEM, CONTROL MODULE AND DISPLAY APPARATUS

(76) Inventors: Wen-Ping Yu, Chung Ho City (TW); Chia-Min Yeh, Chung Ho City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/508,139

(22) Filed: Jul. 23, 2009

(30) Foreign Application Priority Data
Jul. 30, 2008 (TW) 097128806

(51) Int. Cl. H04B 10/12; G09G 5/00

(52) U.S. Cl. 398/141; 345/660

(57) ABSTRACT

The present invention provides a display system. The display system includes a control module, a display apparatus and an optical fiber module. The control module is used to process images and includes a first electrical-to-optical transducer unit for generating a forward light signal according to a digital image signal. The display apparatus is used to display images and includes a first optical-to-electrical transducer unit for transducing the light signal into a scaled image signal. The optical fiber module is coupled to the first electrical-to-optical transducer unit and the first optical-to-electrical transducer unit and is disposed between the control module and the display apparatus that are separated from each other for transmitting the forward light signal from the first electrical-to-optical transducer unit to the first optical-to-electrical transducer unit

### BACKGROUND OF THE INVENTION

1. Field of the invention

This invention relates to a display system, and more particularly, to a display system whose optical fiber can be substitute for general signal lines, to greatly increase the separation distance between the main board and the display apparatus.

2. Description of the related art

Owing to the fast-paced evolution of the electronic technology, the present electronic products have been showing a tendency to be light, thin, short, and small. A former television adopted cathode ray tubes, which causes the size of the television to be larger and thick. Living spaces nowadays are crowded, so to furnish a television with a large and thick size in the house is not easy. And the appearance of the LCD (Liquid-Crystal Display) provides a solution to resolve the above-mentioned problem in certain extent.

An LCD can be used not only for televisions, but also to be the display apparatus of a computer. Please refer to FIG. 1. FIG. 1 is a block diagram illustrating the system of a LCD 1 in a prior art. LCD 1 mainly includes a tuner 100, an audio processor 102, a video decoding chip 104, a VGA (Video Graphics Array) terminal 106, an analog-digital converter 108, a receiver 110, a scalar IC 112, a display apparatus 114, and a loudspeaker 116.

The foregoing VGA terminal 106 can receive an analog image signal or a digital image signal transmitted from a computer (not shown). If the VGA terminal 106 receives an analog image signal, the analog image signal can be converted into a digital image signal by the analog-digital converter 108. If the VGA terminal 106 receives a digital image signal, the digital image signal can be converted into an image signal which has digital level by the receiver 110.

Generally, the monitor of a television or a computer can only display in predetermined resolution. The source image signals are provided by a graphics controller (e.g., a graphics card, a video decoder, a digital camera, etc.), and the resolutions of the source image signals are also predetermined. The source image signals must be scaled to be image signals with an appropriate resolution for the display apparatus 114 to correctly display an output image signal. Therefore, after the foregoing digital image signal is transformed into a video signal adapted to the display apparatus 114 by the scalar IC 112, the display apparatus 114 can display the an analog image signal or a digital image signal.

On the other hand, the foregoing tuner 100 is mainly used to receive a television signal and transmit the image portion in the television signal to the video decoding chip 104, and then the video decoding chip 104 generates a digital image signal. After the digital image signal is transformed into a video signal adapted to the display apparatus 114 by the scalar IC 112, the television signal can be displayed by the display apparatus 114. The audio portion in the television signal is transmitted to the audio processor 102. The audio processor 102 transforms the voice portion in the television signal into a proper audio format and then drives the loudspeaker 116.

Because television systems can be classified to NTSC, PAL, or SECAM, the receiving systems of their tuners are also different. Additionally, the displays can be classified to 17″, 20″, 30″ or other sizes, so the specifications of their power supplies are also different. In order to standardize the production processes and control the cost, separated televisions are therefore developed. The different parts of the separated televisions are moved outside, and the common part is remaining inside the televisions which are generally known as the main board.

Please refer to FIG. 2. FIG. 2 is a schematic diagram illustrating a display system 2 in a prior art. The display system 2 includes a main board 22 and a display apparatus 24. The main board 22 is disposed in a housing 20. The main broad 22 includes a scalar IC 222 and a first transmission interface. The display apparatus 24 includes a second transmission interface 242. The main board 22 and the display apparatus 24 used to transmit a signal by respectively connecting to the first transmission interface 224 and the second transmission interface 242 with a signal line 26. The signal from the first transmission interface 224 is transmitted to the second transmission interface 242 with the signal line 26 which has bus lines structure. Owing to the appearance of the display system 2, the thickness of the display apparatus 24 can still be further reduced.

However, because the size of the displays nowadays are becoming larger, the length of the foregoing signal line 26 must be lengthened, which is accompanied with the inferior quality of signals. Therefore, the length of a present signal line is at most one meter. Moreover, with the increase of resolution and processing speed of a large size display, the requirement bandwidth of transmitting signals is also increased greatly. Due to the limited bandwidth, the signal line might not bear the load of the massive requirement bandwidth. So, without a preferred solution, the complicated bus lines structure between the first transmission interface 224 and the second transmission interface 242 still bothers designers.

Therefore, one scope of the invention is to provide a display system whose optical fiber is mainly used to substitute for the foregoing signal lines and transmit the output signal of the scalar unit to the display apparatus, to greatly increase the separating distance between the main board and the display apparatus up to several hundred meters. In other words, a user can choose the installation location of the display system in the living space at will. The way of adopting an optical fiber to transmit signals of the display system of the invention not only can provide a quite massive transmission bandwidth but also can prevent the complex process of configuring the signal lines.

### SUMMARY OF THE INVENTION

A scope of the invention is to provide a display system. The display system includes a control module, a display apparatus, and an optical fiber module. The control module is used to process image and includes a scaling unit and a first electrical-to-optical transducer unit. The scaling unit is used to scale a digital image signal and output a scaled image signal. The first electrical-to-optical transducer unit is electrically connected to the scaling unit and is able to be used to generate a light signal according to the scaled image signal. The display apparatus is separated from the control module. The display apparatus includes a first optical-to-electrical transducer unit. The first optical-to-electrical transducer unit is able to be used to transduce the light signal into the scaled image signal. The optical fiber module includes at least one optical fiber and is coupled to the first electrical-to-optical transducer unit and the first optical-to-electrical transducer unit respectively and is disposed between the control module and the display apparatus that are separated from each other. The optical fiber module is able to be used to transmit the light signal from the first electrical-to-optical transducer unit to the first optical-to-electrical transducer unit.

Another scope of the invention is to provide a display apparatus. The display apparatus is used in a display system. The display system includes a scaling unit for image processing. The scaling unit and the display apparatus are separated from each other. The display apparatus includes a display unit and an optical fiber module. The display unit is used to display images. The optical fiber module is electrically connected between the display unit and the scaling unit, for transmitting a forward light signal from the scaling unit to the display unit. The optical fiber module further includes at least one optical fiber and a first optical-to-electrical transducer unit for transducing the forward light signal into a scaled image signal. The scaling unit is used to scale a digital image signal into the scaled image signal. The optical fiber module is used to transmit the forward light signal to the first optical-to-electrical transducer unit.

Another scope of the invention is to provide a control module. The control module is used in a display system. The control module includes a housing and a main board. The main board is disposed in the housing. The main board includes a scaling unit and a first electrical-to-optical transducer unit. The scaling unit is disposed on the main board for scaling a digital image signal and outputting a scaled image signal. Then the first electrical-to-optical transducer unit is disposed on the main board, electrically connected to scaling unit, and coupled to an optical fiber module that is disposed out of the housing. The first electrical-to-optical transducer unit is able to be used to transduce the scaled image signal into a light signal, and the light signal is transmitted to the display apparatus of the display system with the optical fiber module. The display apparatus is disposed out of the housing.

Therefore, according to the invention, the optical fiber of the display system is mainly used to substitute for general signal lines and transmit the output signal of the scalar unit to the display apparatus, to greatly increase the separating distance between the main board and the display apparatus up to several hundred meters. In other words, a user can choose the installation location of the display system in the living space at will. The way of adopting an optical fiber to transmit signals of the display system of the invention not only can provide a quite massive transmission bandwidth but also can prevent the complex process of configuring the signal lines.

The advantage and spirit of the invention may be understood by the following recitations together with the appended drawings.

### BRIEF DESCRIPTION OF THE APPENDED DRAWINGS

FIG. 1 is a block diagram illustrating the system of a LCD in a prior art.

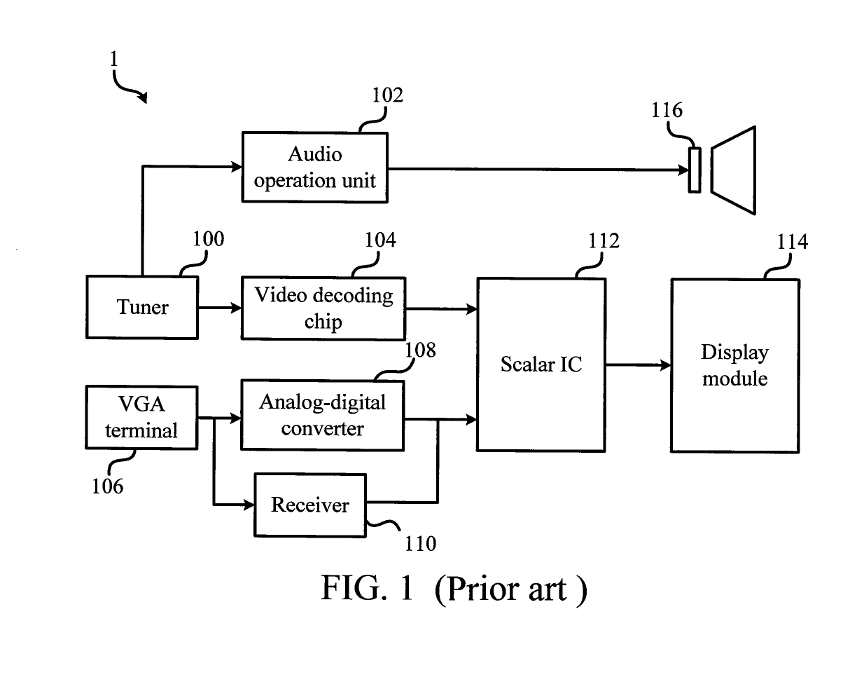

FIG. 2 is a schematic diagram illustrating a display system in a prior art.

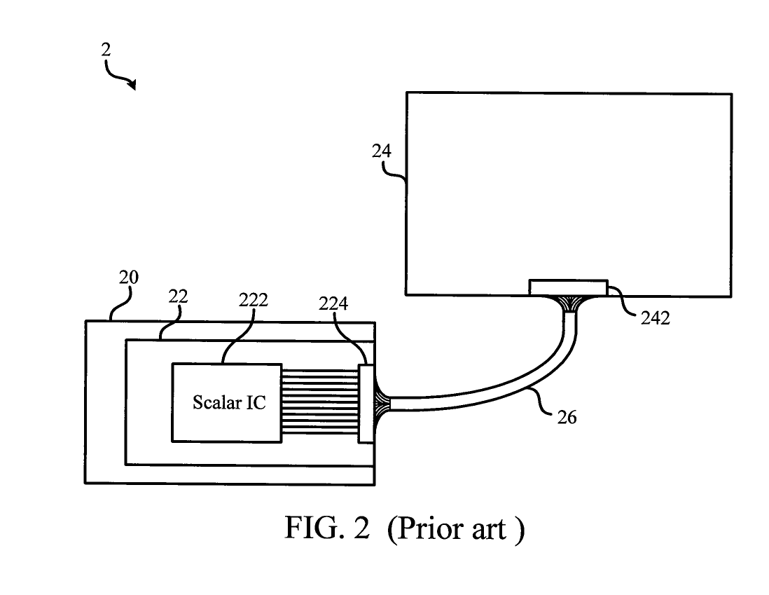

FIG. 3 is a schematic diagram illustrating a display system according to a preferred embodiment of the invention.

FIG. 4 is a schematic diagram illustrating a display system according to anther the preferred embodiment of the invention.

### DETAILED DESCRIPTION OF THE INVENTION

The scope of the invention is to provide a display system. The optical fiber of the display system which substitutes for general signal lines not only greatly increases the separating distance between the main board and the display apparatus but also provides a quite massive transmission bandwidth and prevents the complex process of configuring the signal lines. The following will relate in detail this invention the preferred embodiments, to explain characteristic, the spiritual, the merit as well as implementation in this invention simple fully.

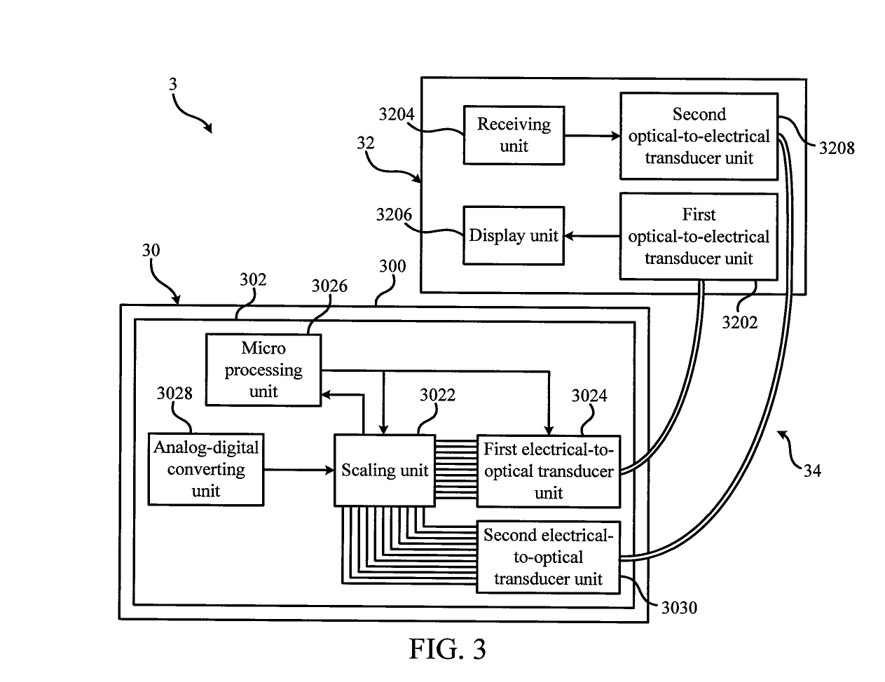

Please refer to FIG. 3. FIG. 3 is a schematic diagram illustrating a display system 3 according to a preferred embodiment of the invention. As shown in FIG. 3, the display system 3 includes a control module 30, a display apparatus 32, and an optical fiber module 34. The control 30 includes a housing 300 and a main board 302. The main board 302 is disposed in housing 300. The main board 302 includes a first electrical-to-optical transducer unit 3024. The first electrical-to-optical transducer unit 3024 is mainly used to generate a forward light signal according to a received digital image signal. The optical fiber module 34 includes at least one optical fiber and is coupled to the first electrical-to-optical transducer unit 3024 of the main board 302 and extended out of the housing 300. The display apparatus 32 is coupled to the optical fiber module 34 and separated form the housing 300. The forward light signal that is generated by the first electrical-to-optical transducer unit 3024 can be transmitted to the display apparatus 32 through the optical fiber module 34. The display system 3, including the structures, the functions, and the actuating approaches thereof, according to the preferred embodiment of the invention will be introduced and expressed in detail below.

As shown in FIG. 3, in the embodiment, the display apparatus 32 according to the invention can further include a first optical-to-electrical transducer unit 3202 and a display unit 3206. The first optical-to-electrical transducer unit 3202 is coupled to an end of the optical fiber module 34 that extends out of the housing 300. When the forward light signal which is outputted from the first electrical-to-optical transducer unit 3024 is transmitted to the display apparatus 32 through the optical fiber module 34, the first optical-to-electrical transducer unit 3202 of the display apparatus 32 is able to transduce the forward light signal into a scaled image signal. The display unit 3206 is electrically connected to the first optical-to-electrical transducer unit 3202. For example, the display unit 3206 can be a LCD panel. Thereby, the display apparatus 32 can use the display unit 3206 to display the scaled image signal. It is notable that the optical fiber module 34 is detachably connected or directly coupled between the housing 300 of the control module 30 and the display apparatus 32.

As shown in FIG. 3, in the embodiment, the main board 302 of the control module 30 of the invention can further include a scaling unit 3022. The scaling unit 3022 can include a scaling IC which is electrically connected to the first electrical-to-optical transducer unit 3024. The scaling unit 3022 can be used to scale the foregoing digital image signal and output the scaled image signal. Subsequently, the scaled image signal which is outputted from the scaling unit 3022 can be transduced into the foregoing forward light signal by the first electrical-to-optical transducer unit 3024.

As shown in FIG. 3, in the embodiment, the main board 302 of the control module 30 of the invention can further include a micro processing unit 3026. The micro processing unit 306 is electrically connected to the scaling unit 3022 and the first electrical-to-optical transducer unit 3024 respectively. The micro processing unit 3026 is capable of driving the scaling unit 3022 to scale the foregoing digital image signal and driving the first electrical-to-optical transducer unit 3024 to transduce the foregoing scaled image signal.

As shown in FIG. 3, in the embodiment, the main board 302 of the control module 30 of the invention can further include an analog-digital converting unit 3028. The analog-digital converting unit 3028 is electrically connected to the scaling unit 3022. The analog-digital converting unit 3028 is capable of converting a received analog image signal into the foregoing digital image signal and then inputting the digital image signal to the scaling unit 3022.

It is notable that the main board 302 of the control module 30 of the display system 3 according to the invention is not limited to include the foregoing scaling unit 3022, the micro processing unit 3026, and the analog-digital converting unit 3028 only. The scaling unit 3022, the micro processing unit 3026, and the analog-digital converting unit 3028 mentioned above can be just regarded as an example. Presently, the processing units of the main boards of display apparatuses which are developed to conform to various kinds of input signal sources can be applied to the main board 302 of the display system 3 in the invention, so they will not be redundantly explained. For example, the format of the foregoing digital image signal conforms to, but not limited to, the standard of HDCP.

It is notable that the optical fiber module 34 can be connected between the control module 30 and the display apparatus 32 in the display system 3 of the invention to provide a massive separation distance. For example, if the display apparatus 32 is a television, a user can place the control module 30 that is used to process signals beside the seat and place the display apparatus 32 on the television cabinet. Because the display apparatus 32 of the invention lacks the main board 302 that is originally disposed at the back portion of the television, the thickness of the television can be reduced. If the control module 30 is moved to be adjacent to the seat, the user can conveniently operate the control module 30. In addition, the length of the optical fiber module 34 that is used to coupled to the control module 30 and the display apparatus 32 can be easily lengthened to one meter or longer.

As above, although the control module 30 of the display system 3 of the prefer embodiment according to the invention is placed beside the seat, people still often operate the remote controller toward the display apparatus 32 rather than toward the control module 30 instinctively according to their consumption customs of operating display apparatuses. Therefore, in an embodiment, the display apparatus 32 in the display system 3 according to the invention can further include a receiving unit 3204 and a second electrical-to-optical transducer unit 3208, as shown in FIG. 3. The receiving unit 3204 is electrically connected to the second electrical-to-optical transducer unit 3208. The receiving unit 3204 can be used to receive the control signal that is emitted by the remote controller operated by the user. Generally, the control signal can be, but not limited to, an infrared signal or a radio frequency signal. After the receiving unit 3204 receives the control signal, the second electrical-to-optical transducer unit 3208 of the display apparatus 32 is capable of transducing the control signal into a backward light signal. The backward light signal can be transmitted to the main board 302 of the control module 30 immediately through the optical fiber module 34. The control module 30 further comprises a second optical-to-electrical transducer unit 3030. Subsequently, the backward light signal can be transduced into the control signal by the second optical-to-electrical transducer unit 3030. The control signal is used to control the operation of the control module 30. So, users can control the display apparatus 32 by operating the remote control toward the display apparatus 32 wireless as usual without changing the consumption custom of operating a display apparatus.

It is notable that the optical fiber module 34 of the display system 3 of the invention can further include at least one optical fiber, such as a plastic optical fiber. To conform to the data of the scaled image signal outputted by the scaling unit 3022, the number of optical fibers in the optical fiber module 34 and the corresponding quantity for transmitting data depend on different requirements or designers. For example, the number of optical fibers and the corresponding quantity for transmitting data depend on the design of the scaling unit 3022.

Additionally, the foregoing display apparatus 32 can be, but not limited to, a television, a monitor, a projector, or a TV wall. For example, the TV wall can be applied to the display in the showcase or an outdoor large size display and adopt display mechanisms such as, but not limited to, LCD, LED, or projection.

Furthermore, there is no scaling unit disposed in the display apparatus 32 of the invention. The scaled image signal is directly provided by the scaling unit 3022 in the control module 30, and the scaled image signal then is provided to the display unit 3206 through the first electrical-to-optical transducer unit 3024, the optical fiber module 34, and the first optical-to-electrical transducer unit 3202 for displaying the foregoing digital image signal. However, in another example, the display apparatus 32 can further include a scaling unit (not shown) for processing the signals from the devices such as the first optical-to-electrical transducer unit 3202.

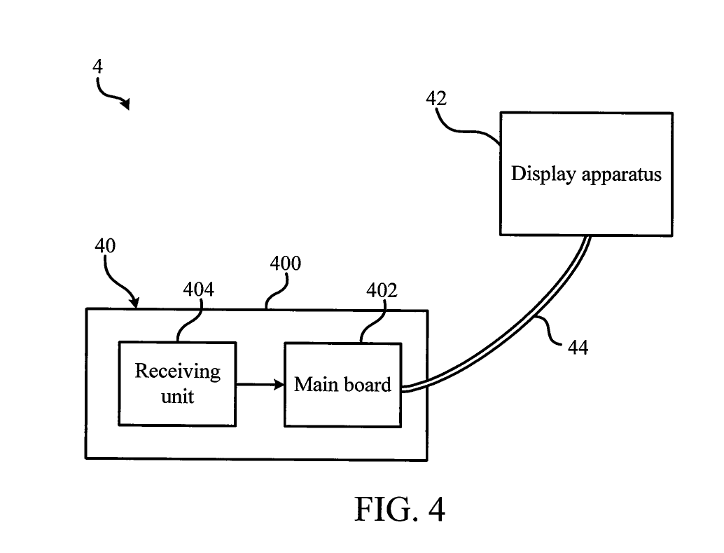

Please refer to FIG. 4. FIG. 4 is a schematic diagram illustrating a display system 4 according to anther the preferred embodiment of the invention. In the embodiment, the receiving unit 404 which is used to receive the control signal can also be disposed in the housing 400 of the control module 40 and electrically connected to the main board 402. Thereby, the received control signal can be transmitted to the main board 402. With the hardware configuration, users can also wirelessly operate the remote control toward the control module 40 beside the seat and control the display apparatus 42 through the optical fiber module 44. Furthermore, the main board 402 can include a first electrical-to-optical transducer unit, and the display apparatus 42 can include a first optical-to-electrical transducer unit (not shown), wherein the optical fiber module 44 is coupled between the first electrical-to-optical transducer unit and the first optical-to-electrical transducer unit for transmitting light signals between the display apparatus 42 and the control module 40. Additionally, the main board 402 can further include a scaling unit, a micro processing unit, and an analog-digital converting unit, and the display apparatus 42 can further include a display unit (not shown), wherein the relationships and the interactions among all elements can be the same to those of the former embodiment.

Based on the foregoing embodiments of the invention, it is obvious that the optical fiber of the display system is mainly used to substitute for general signal lines and transmit the output signal of the scalar unit to the display apparatus, to greatly increase the separating distance between the main board and the display apparatus up to several hundred meters. In other words, a user can choose the installation location of the display system in the living space at will. The way of adopting an optical fiber to transmit signals of the display system of the invention not only can provide a quite massive transmission bandwidth but also can prevent the complex process of configuring the signal lines. The signal transmitting bandwidth of an optical fiber can meet the requirement of transmitting speed of Full HD which gradually becomes a master stream.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. A display system, comprising:
a control module for image processing, comprising a first electrical-to-optical transducer unit for generating a forward light signal according to a digital image signal;
a display apparatus for image displaying, comprising a first optical-to-electrical transducer unit for transducing the forward light signal into a scaled image signal; and
an optical fiber module, comprising at least one optical fiber coupled to the first electrical-to-optical transducer unit and the first optical-to-electrical transducer unit and disposed between the control module and the display apparatus that are separated from each other, for transmitting the forward light signal from the first electrical-to-optical transducer unit to the first optical-to-electrical transducer unit.

2. The display system of claim 1, wherein the control module further comprises a scaling unit for scaling the digital image signal and outputting the scaled image signal, and the first electrical-to-optical transducer unit transduces the scaled image signal into the forward light signal.

3. The display system of claim 2, wherein the control module further comprises:
a housing; and
a main board being disposed in the housing, wherein both the scaling unit and the first electrical-to-optical transducer unit are disposed on the main board, and the optical fiber module extends out of the housing from the first electrical-to-optical transducer unit, so as to couple to the first optical-to-electrical transducer unit of the display apparatus.

4. The display system of claim 3, wherein the optical fiber module is detachably connected between the housing and the display apparatus.

5. The display system of claim 3, wherein the control module further comprises a micro processing unit, the micro processing unit is disposed on the main board, the micro processing unit is electrically connected to the scaling unit and the first electrical-to-optical transducer unit respectively, and the micro processing unit is capable of driving the scaling unit to scale the digital image signal and driving the first electrical-to-optical transducer unit to transduce the scaled image signal.

6. The display system of claim 3, wherein the control module further comprises an analog-digital converting unit, the analog-digital converting unit is electrically connected to the scaling unit for converting an analog image signal into the digital image signal and then inputting the digital image signal to the scaling unit.

7. The display system of claim 1, further comprising a receiving unit, disposed in the housing and electrically connected to the main board, for receiving a control signal and transmitting the control signal to the main board.

8. The display system of claim 1, wherein the display apparatus further comprises a receiving unit and a second electrical-to-optical transducer unit, the receiving unit is for receiving a control signal inputted by a user and electrically connected to the second electrical-to-optical transducer unit, the second electrical-to-optical transducer unit is capable of transducing the control signal into a backward light signal, the backward light signal then be transmitted to the main board through the optical fiber module.

9. The display system of claim 8, wherein the control module further comprises a second optical-to-electrical transducer unit which is capable of transducing the backward light signal into the control signal, the control signal is used to control the operation of the control module.

10. The display system of claim 1, wherein the display apparatus is one selected from the group consisting of a television, a monitor, a projector, and a video wall.

11. The display system of claim 1, wherein the format of the digital image signal conforms to the standard of HDCP.

12. A display apparatus, used in a display system which comprises a scaling unit for image processing, the scaling unit being separated from the display apparatus, the display apparatus comprising:
a display unit for image displaying; and
an optical fiber module electrically connected between the display unit and the scaling unit, for transmitting a forward light signal from the scaling unit to the display unit.

13. The display apparatus of claim 12, wherein the optical fiber module further comprises at least one optical fiber and a first optical-to-electrical transducer unit for transducing the forward light signal into a scaled image signal, wherein the scaling unit is used to scale a digital image signal into the scaled image signal, and the optical fiber module is used to transmit the forward light signal to the first optical-to-electrical transducer unit.

14. The display apparatus of claim 13, further comprising a receiving unit and a second electrical-to-optical transducer unit, the receiving unit is for receiving a control signal inputted by a user and electrically connected to the second electrical-to-optical transducer unit, the second electrical-to-optical transducer unit is capable of transducing the control signal into a backward light signal which is then transmitted to the scaling unit through the optical fiber module.

15. The display apparatus of claim 14, wherein the scaling unit of the display system comprises a second optical-to-electrical transducer unit being capable of transducing the backward light signal into the control signal.

16. The display apparatus of claim 15, wherein the control signal is emitted by a remote controller, and the control signal is an infrared signal or a radio frequency signal.

17. A control module, used in a display system, the control module comprising:
a housing; and
a main broad, disposed in the housing, the main broad comprising:
a scaling unit, disposed on the main broad, for scaling a digital image signal and outputting a scaled image signal; and
a first electrical-to-optical transducer unit, disposed on the main broad, electrically connected to the scaling unit, and coupled to an optical fiber module disposed out of the housing, for transducing the scaled image signal into a light signal and transmitting the light signal to a display apparatus of the display system through the optical fiber module, wherein the display apparatus being disposed out of the housing.

18. The control module of claim 17, further comprising a micro processing unit, disposed on the main board and electrically connected to the scaling unit and the first electrical-to-optical transducer unit respectively, the micro processing unit being capable of driving the scaling unit to scale the digital image signal and driving the first electrical-to-optical transducer unit to generate the light signal.

19. The control module of claim 18, further comprising an analog-digital converting unit, electrically connected to the scaling unit, for converting an analog image signal into the digital image signal and then inputting the digital image signal to the scaling unit.
